(19) United States
(12) Patent Application Publication
(10) Pub. No.: US 2026/0127039 A1
(43) Pub. Date: May 7, 2026

(54) SYSTEM AND METHOD FOR CONSOLIDATING COMMON RESOURCE UNITS

(71) Applicant: The Toronto-Dominion Bank, Toronto (CA)

(72) Inventors: Amanda VAZANTE, Oakville (CA); Romy MOGHAIZEL, Toronto (CA)

(73) Assignee: The Toronto-Dominion Bank, Toronto (CA)

(21) Appl. No.: 18/934,739

(22) Filed: Nov. 1, 2024

(51) Int. Cl. G06F 9/50

(52) U.S. Cl. CPC G06F 9/5077

(57) ABSTRACT

A server computer system comprises at least one processor; a communications module coupled to the at least one processor; and a memory coupled to the at least one processor, the memory storing instructions that, when executed, configure the at least one processor to identify at least one common resource unit that is found on at least one data record of a first resource node and at least one data record of a second resource node; generate a recommendation to consolidate the at least one common resource unit by removing the at least one common resource unit from at least one future data record of the second resource node and retaining the at least one common resource unit on at least one future data record of the first resource node; send, via the communications module and to a computing device, a signal causing the computing device to display the recommendation and at least one selectable interface element for accepting the recommendation; receive, via the communications module and from the computing device, a signal indicating selection of the selectable interface element for accepting the recommendation; perform operations to consolidate the at least one common resource unit by removing the at least one common resource unit from the at least one future data record of the second resource node and retaining the at least one common resource unit on the at least one future data record of the first resource node.

### TECHNICAL FIELD

The present application relates to systems and methods for consolidating common resource units.

### BACKGROUND

Resource nodes such as virtual machines often operate independently while accessing or consuming resource units. In some instances, multiple resource nodes may independently allocate memory for one or more of the same resource units and this may lead to inefficiencies such as redundant memory usage. This duplication may further strain resources, limit scalability, and can result in performance degradation.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for consolidating common resource units; and

FIGS. 4A and 4B show an example of data records of first and second resource nodes, respectively;

FIGS. 5A and 5B show another example of data records of first and second resource nodes, respectively;

FIG. 6 shows an example recommendation to consolidate common resource units;

FIGS. 7A and 7B show an example of future data records of first and second resource nodes, respectively;

FIGS. 8A and 8B show another example of future data records of first and second resource nodes, respectively.

Like reference numerals are used in the drawings to denote like elements and features.

### DETAILED DESCRIPTION OF VARIOUS EMBODIMENTS

Accordingly, in one aspect there is provided a server computer system comprising at least one processor; a communications module coupled to the at least one processor; and a memory coupled to the at least one processor, the memory storing instructions that, when executed, configure the at least one processor to identify at least one common resource unit that is found on at least one data record of a first resource node and at least one data record of a second resource node; generate a recommendation to consolidate the at least one common resource unit by removing the at least one common resource unit from at least one future data record of the second resource node and retaining the at least one common resource unit on at least one future data record of the first resource node; send, via the communications module and to a computing device, a signal causing the computing device to display the recommendation and at least one selectable interface element for accepting the recommendation; receive, via the communications module and from the computing device, a signal indicating selection of the selectable interface element for accepting the recommendation; and perform operations to consolidate the at least one common resource unit by removing the at least one common resource unit from the at least one future data record of the second resource node and retaining the at least one common resource unit on the at least one future data record of the first resource node.

In one or more embodiments, the at least one data record includes at least one memory table and the at least one common resource unit includes memory allocation found on the at least one memory table.

In one or more embodiments, the second resource node is provided access to the at least one common resource unit based on the at least one common resource unit being retained in the at least one future data record of the first resource node.

In one or more embodiments, the instructions, when executed, further configure the at least one processor to analyze the at least one data record of the first node and the at least one data record of the second node to identify the at least one common resource unit.

In one or more embodiments, the at least one common resource unit is identified at least by an identifier of the at least one common resource unit.

In one or more embodiments the identifier includes at least one of a virtual address, a physical page number, a page frame number, or a merchant identifier.

In one or more embodiments, the at least one common resource unit is associated with providing access to a particular resource.

In one or more embodiments, when performing the operations to consolidate the at least one common resource unit by removing the at least one common resource unit from the at least one future data record of the second resource node, the instructions, when executed, further configure the at least one processor to send, via the communications module and to the computing device, a signal causing the computing device to display a selectable interface element that includes a deep link embedded therein that causes the computing device to navigate to a web page for requesting the removal of the at least one common resource unit from the at least one future data record of the second resource node.

In one or more embodiments, retaining the at least one common resource unit in the at least one future data record of the first resource node includes increasing an allocation of the at least one common resource unit to a higher value.

In one or more embodiments, the instructions, when executed, further configure the at least one processor to send, via the communications module and to a second computing device, a signal causing the computing device to display a selectable interface element that includes a deep link embedded therein that causes the computing device to navigate to a web page for increasing the allocation of the at least one common resource unit to the higher value in the at least one future data record of the first resource node.

In one or more embodiments, when identifying the at least one common resource unit, the instructions, when executed, further configure the at least one processor to determine that the at least one common resource unit appears at least a threshold number of times in the at least one data record of the first resource node or the at least one data record of the second resource node.

According to another aspect there is provided a computer-implemented method comprising identifying at least one common resource unit that is found in at least one data record of a first resource node and at least one data record of a second resource node; generating a recommendation to consolidate the at least one common resource unit by removing the at least one common resource unit from at least one future data record of the second resource node and retaining the at least one common resource unit on at least one future data record of the first resource node; sending, via a communications module and to a computing device, a signal causing the computing device to display the recommendation and at least one selectable interface element for accepting the recommendation; receiving, via the communications module and from the computing device, a signal indicating selection of the selectable interface element for accepting the recommendation; and performing operations to consolidate the at least one common resource unit by removing the at least one common resource unit from the at least one future data record of the second resource node and retaining the at least one common resource unit on the at least one future data record of the first resource node.

In one or more embodiments, the second resource node is provided access to the at least one common resource unit based on the at least one common resource unit being retained in the at least one future data record of the first resource node.

In one or more embodiments, the method further comprises analyzing the at least one data record of the first node and the at least one data record of the second node to identify the at least one common resource unit.

In one or more embodiments, the at least one common resource unit is identified at least by an identifier of the at least one common resource unit.

In one or more embodiments, the identifier includes at least one of a virtual address, a physical page number, a page frame number, or a merchant identifier.

In one or more embodiments, the at least one common resource unit is associated with providing access to a particular resource.

In one or more embodiments, when performing the operations to consolidate the at least one common resource unit by removing the at least one common resource unit from the at least one future data record of the second resource node, the method further comprises sending, via the communications module and to the computing device, a signal causing the computing device to display a selectable interface element that includes a deep link embedded therein that causes the computing device to navigate to a web page for requesting the removal of the at least one common resource unit from the at least one future data record of the second resource node.

In one or more embodiments, retaining the at least one common resource unit in the at least one future data record of the first resource node includes increasing an allocation of the at least one common resource unit to a higher value.

According to another aspect there is provided a non-transitory computer readable storage medium comprising processor-executable instructions which, when executed, configure at least one processor to identify at least one common resource unit that is found on at least one data record of a first resource node and at least one data record of a second resource node; generate a recommendation to consolidate the at least one common resource unit by removing the at least one common resource unit from at least one future data record of the second resource node and retaining the at least one common resource unit on at least one future data record of the first resource node; send, via a communications module and to a computing device, a signal causing the computing device to display the recommendation and at least one selectable interface element for accepting the recommendation; receive, via the communications module and from the computing device, a signal indicating selection of the selectable interface element for accepting the recommendation; and perform operations to consolidate the at least one common resource unit by removing the at least one common resource unit from the at least one future data record of the second resource node and retaining the at least one common resource unit on the at least one future data record of the first resource node.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of ...or...” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

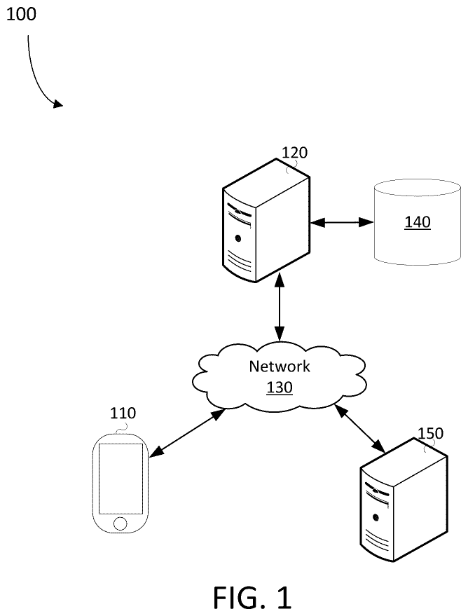

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may be associated with a user or customer having resources that are managed by or via the server computer system 120. For example, the server computer system 120 may be a financial institution server and the user may be a customer of a financial institution operating the financial institution server. The computing device 110 may store software instructions that cause the computing device 110 to establish communications with the server computer system 120.

The server computer system 120 may manage services, data records, and computational resources across a distributed computing environment. The server computer system 120 may allocate resources, store data, and perform computational tasks for various resource nodes such as for example virtual machines, customer accounts, or applications. The resource nodes may operate under the management of a hypervisor that may be configured to manage virtual computing environments. The server computer system 120 may include a cloud-based server computer system.

The server computer system 120 may maintain one or more databases 140 that may store data records that pertain to different resource nodes. These data records may include resource usage data for virtual machines such as memory allocations, CPU usage, etc. These data records may additionally or alternatively include account data such as for example bank account data or credit card transaction data.

As will be described in more detail below, the server computer system 120 may identify and manage common resource units across different resource nodes. For example, the resource nodes may include virtual machines running under the control of a hypervisor. The virtual machines may access shared memory tables, data blocks, or other computational resources. The server computer system 120 may, in cooperation with the hypervisor, detect when multiple virtual machines are utilizing the same resource unit such as for example the same memory table or data block and may perform operations to consolidate resource usage.

The server computer system 120 may operate in a cloud-based architecture which may allow for dynamic resource allocation and scalability. For example, the hypervisor may manage the lifecycle of virtual machines within the cloud infrastructure allowing the server computer system 120 to optimize memory usage, storage and computational resources across the virtual machines.

The server computer system 120 may include a resource management module that may be configured to track resource usage data of each virtual machine and generate recommendations to optimize resource allocation by consolidating common resource units.

In one or more embodiments, the server computer system 120 may integrate with one or more third party servers through one or more application programming interfaces (APIs). For example, the server computer system 120 may integrate with one or more third party servers in an open banking framework. In this example, a third party financial institution may offer account data such as for example bank account data or credit card transaction data to the server computer system 120 via a secure API. By leveraging open banking protocols, the server computer system 120 may access and consolidate account data from multiple sources providing a unified view of financial transactions and/or balances.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

Although not shown, in one or more embodiments, the system 100 may include one or more third party servers that may be associated with a third party that provides a particular service. For example, the third party server may be associated with a streaming service provider, a utility service provider, an internet provider, a cable provider, a third party financial institution, a credit card provider, etc.

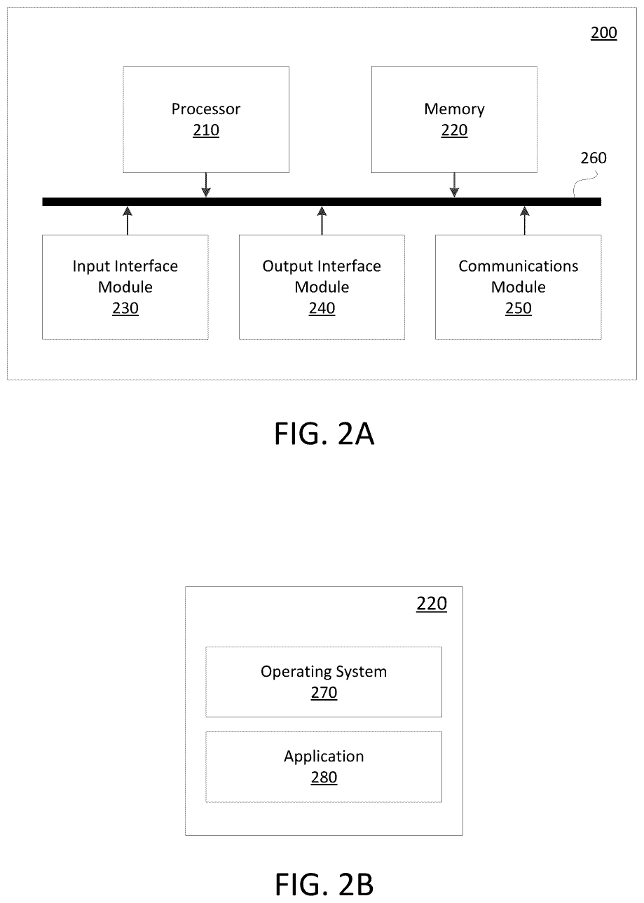

FIG. 2A is a high-level operation diagram of an example computer device 200. In some embodiments, the example computer device 200 may be exemplary of one or more of the computing device 110, the server computer system 120 and/or the third party server 150. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux^{TM}, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations. For example, in at least some embodiments in which the computer device 200 is functioning as the computing device 110, the applications 280 may include a banking application. The banking application may be configured for secure communications with the server computer system 120 and may provide various banking functions such as, for example, the ability to display a quantum of value in one or more data records (e.g. display balances), configure or request that operations such as transfers of value (e.g. bill payments, email money transfers and other transfers) be performed, and other account management functions.

By way of further example, in at least some embodiments in which the computer device 200 functions as the computing device 110, the applications 280 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

By way of further example, in at least some embodiments in which the computer device 200 functions as the computing device 110, the applications 280 may include a resource management module. The resource management module may track resource usage data of one or more resource nodes and may generate recommendations to optimize resource allocation by consolidating common resource units.

The resource management module hosted or provided by the server computer system 120 may be accessed on the computing device 110. For example, a user may select a selectable interface element within a mobile application that, when selected, directs the computing device 110 to the resource management module. As another example, the resource management module may be downloaded as an application onto the computing device 110. As another example, the computing device 110 may access the resource management module using an internet browser resident on the computing device 110. As yet another example, the computing device 110 may access the resource management module by way of one or more APIs.

In one or more embodiments, the user may be required to provide authentication information to access the resource management module. For example, using the computing device 110, the user may enter a username and password and the computing device 110 may send a signal that includes the username and password to the server computer system 120. The server computer system 120 may verify the authentication information and may identify the account of the user.

The server computer system 120 may obtain or retrieve resource usage data from one or more sources. For example, the server computer system 120 may engage one or more monitoring tools to track resource usage. The monitoring tools may be configured to obtain resource usage data that includes CPU utilization, memory allocation, storage consumption, network bandwidth, etc. As another example, the server computer system 120 may engage one or more APIs to obtain the resource usage data from one or more third party servers. As yet another example, the server computer system 120 may maintain logs that record activities related to resource usage. This includes logs from applications, virtual machines, and/or user activities that can be analyzed to identify how resources are consumed.

The resource usage data may be obtained separately for each resource node. For example, resource usage data of a first resource node may be obtained separately from resource usage data of a second resource node. In this manner, the server computer system 120 may serve as a central resource manager where the resource usage data may be obtained separately for each resource node.

The resource usage data may be obtained from the same sources or from different sources for each resource node. For example, resource usage data of a first resource node may be obtained from two sources and resource usage data of a second resource node may be obtained from two different sources. As another example, resource usage data of a first resource node may be obtained from a first source and a second source and resource usage data of a second resource node may be obtained from the first source and a third source.

In one or more embodiments, the server computer system 120 may obtain or retrieve resource usage data from one or more sources using a data ingestion engine. The data ingestion engine may be configured to communicate with the one or more sources directly and/or by way of one or more APIs. The data ingestion engine may include a network analyzer that may monitor network traffic. The data ingestion engine may only ingest the data when it is determined that the network traffic is below a threshold and this be done to reduce the reliance on computing resources.

The resource usage data may be stored as data records where each data record may represent a specific resource usage instance of a resource such as for example memory allocation for a virtual machine. The data records may include an identification of the resource node and resource units utilized by the resource node. The resource units may be identified using, for example, an identifier. The identifier may include at least one of a virtual address, a physical page number, a page frame number or a merchant identifier.

In one or more embodiments, the data records may include at least one memory table of a virtual processor and the resource units may include memory allocation.

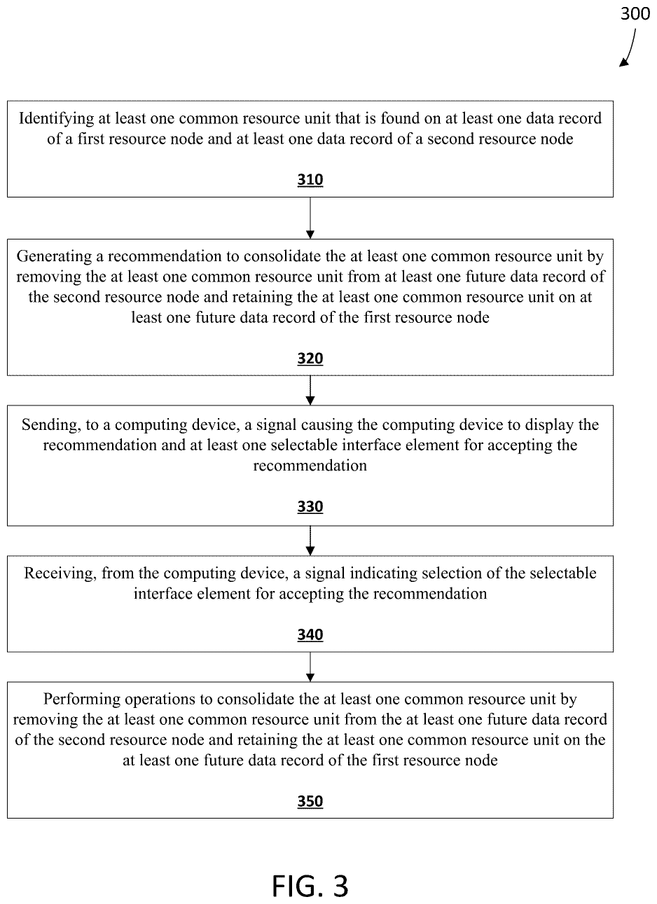

Once the server computer system 120 has obtained the resource usage data, the server computer system 120 may perform operations to consolidate common resource units. Reference is made to FIG. 3, which illustrates, in flowchart form, a method 300 for consolidating common resource units. The method 300 may be implemented by a computing device having suitable processor-executable instructions for causing the computing device to carry out the described operations. The method 300 may be implemented, in whole or in part, by the server computer system 120 within the resource management module. The server computer system 120 may off-load some operations of the method 300 to the computing device 110 (FIG. 1).

The method 300 includes identifying at least one common resource unit that is found in at least one data record of a first resource node and at least one data record of a second resource node (step 310).

As mentioned, the resource usage data may be stored as data records. The at least one common resource unit may include at least one resource unit that is found both in at least one data record of a first resource node and at least one data record of a second resource node.

In one or more embodiments, the server computer system 120 may analyze the at least one data record of the first resource node and the at least one data record of the second resource node to identify the at least one common resource unit.

To identify the at least one common resource unit, the server computer system 120 may utilize an identifier of the at least one common resource unit. For example, as mentioned, resource units may be identified using an identifier such as for example a virtual address, a physical page number, a page frame number or a merchant identifier. As such, the server computer system 120 may identify the at least one common resource unit in response to determining that the same identifier is found in both the at least one data record of the first resource node and the at least one data record of the second resource node.

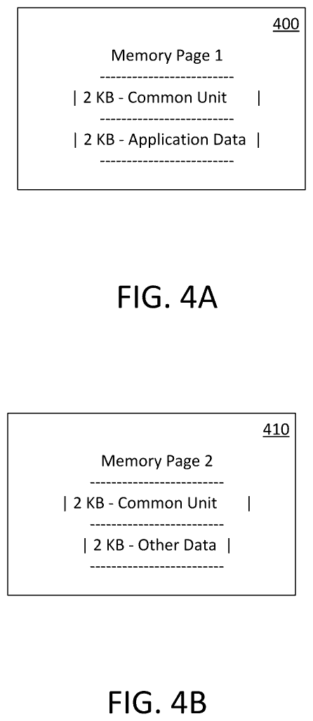

An example data record of a first resource node is shown in FIG. 4A. In this example, the first resource node includes a virtual processor and the data record includes a memory table 400.

An example data record of a second resource node is shown in FIG. 4B. In this example, the second resource node includes a virtual processor and the data record includes a memory table 410.

The server computer system 120 may analyze the memory table 400 and the memory table 410 and may identify the at least one common resource unit based on a determination that the memory table 400 and the memory table 410 include the common unit.

In one or more embodiments, the server computer system 120 may identify the at least one common resource unit when it is determined that the at least one common resource unit appears at least a threshold number of time in at least one of the data records of at least one of the first resource node or the second resource node. For example, the server computer system 120 may analyze the at least one data record of the first resource node and may identify that an identifier of a particular resource unit appears at least two times. The server computer system 120 may then determine that the identifier of the particular resource unit appears in the at least one data record of the second resource node and thus may identify the particular resource unit as the common resource unit. It will be appreciated that the identifier of the particular resource unit may only be required to appear the threshold number of times in one of the data records of the first resource node or the data records of the second resource node or may be required to appear the threshold number of times in the data records of the first resource node and in the data records of the second resource node. In this manner, the server computer system 120 may identify the at least one common resource unit only when the identifier of the at least one common resource unit appears the threshold amount of times in at least one of the data records.

As mentioned, the at least one common resource unit may include at least one resource unit that is found both in the at least one data record of the first resource node and the at least one data record of the second resource node. The at least one common resource unit may be identified solely on the identifier being the same in the at least one data record of the first resource node and the at least one data record of the second resource node. For example, a particular resource unit may be identified using a fifteen digit identifier code. The fifteen digit identifier code may be found in the at least one data record of the first resource node and the data record may also include a value associated with the particular resource unit such as for example 10. The fifteen digit identifier code may be found in the at least one data record of the second resource node and the data record may also include a value associated with the particular resource unit such as for example 5. As such, the particular resource unit may be identified as the at least one common resource unit regardless of whether the value of the particular resource unit is the same in the at least one data record of the first resource node and the at least one data record of the second resource node is different.

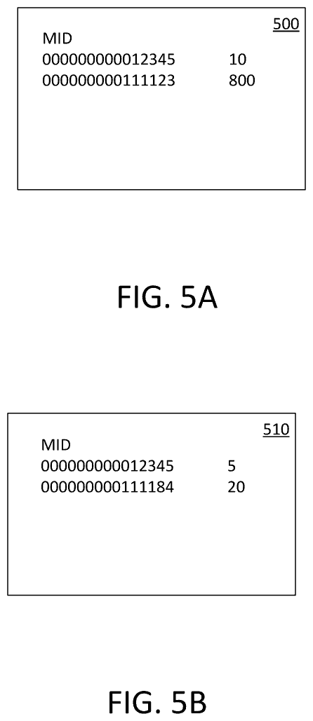

An example is shown in FIGS. 5A and 5B. In FIG. 5A, a data record 500 associated with a first resource node is listed with MID 000000000012345 and has a value of 10. In FIG. 5B, a data record 510 associated with a second resource node is listed with MID 000000000012345 and has a value of 5. The server computer system 120 may analyze the data records 500 and 510 and may identify the at least one common resource unit as being MID 000000000012345.

The method 300 includes generating a recommendation to consolidate the at least one common resource unit by removing the at least one common resource unit from at least one future data record of the second resource node and retaining the at least one common resource unit on at least one future data record of the first resource node (step 320).

To generate the recommendation, the server computer system 120 may determine whether or not the at least one common resource unit can be consolidated and this may be based on a characteristic of the at least one common resource unit and/or usage of the at least one common resource unit. For example, the at least one common resource unit may include memory tables used by different virtual machines that may be consolidated using techniques such as memory deduplication or memory ballooning to reduce overall memory consumption. As another example, the at least one common resource unit may include storage blocks such as for example files, snapshots, backup images, that may be stored across multiple systems of virtual machines and may be consolidated using techniques such as deduplication to remove redundant data. As yet another example, the at least one common resource unit may include shared libraries or code that may be consolidated to avoid loading duplicate copies into memory thereby allowing for efficient use of computer resources. As yet another example, the at least one common resource unit may be associated with providing access to a particular resource. For example, the at least one common resource unit may include common charges on multiple financial accounts such as for example subscription fees that may be consolidated to maintain the charge on a primary account and removing duplicate charges from the other accounts. As still yet another example, the at least one common resource unit may include a determination that multiple resource nodes are using bandwidth for the same data or service and thus may be consolidated to optimize network traffic, potentially reducing redundancy by caching data or rerouting through a shared node.

In one or more embodiments, the server computer system 120 may determine that the at least one common resource unit cannot be consolidated and this may be based on a characteristic of the at least one common resource unit and/or usage of the at least one common resource unit. For example, memory tables that include unique data specific to a particular virtual machine cannot be consolidated. As another example, data that is unique to specific applications running on different virtual machines such as session data or user-specific configurations cannot be consolidated. As yet another example, storage blocks that require write-intensive operations cannot be consolidated as this may cause data corruption. Security tokens, encryption keys, or other cryptographic data are unique to individual resource nodes and cannot be consolidated.

In one or more embodiments, the server computer system 120 may analyze the identifier of the at least one common resource unit and may consult a database to determine whether or not the at least one common resource unit can be consolidated. For example, the database may include a list of resource units and an indication as to whether or not the at least one common resource unit is able to be consolidated.

Responsive to identifying that the at least one common resource unit can be identified, the server computer system 120 may generate the recommendation.

Referring to the example shown in FIGS. 4A and 4B, the server computer system 120 may generate a recommendation to consolidate the common unit by removing it from the memory table 410 of the second resource node and retaining the common unit on the memory table 400 of the first resource node.

Referring to the example shown in FIGS. 5A and 5B, the server computer system 120 may generate a recommendation to consolidate MID 000000000012345 by removing it from the data record 510 of the second resource node and retaining it on the data record 500 of the first resource node.

The method 300 includes sending, to a computing device, a signal causing the computing device to display the recommendation and at least one selectable interface element for accepting the recommendation (step 330).

Responsive to generating the recommendation, the server computer system 120 sends a signal causing the computing device 110 to display the recommendation and at least one selectable interface element for accepting the recommendation.

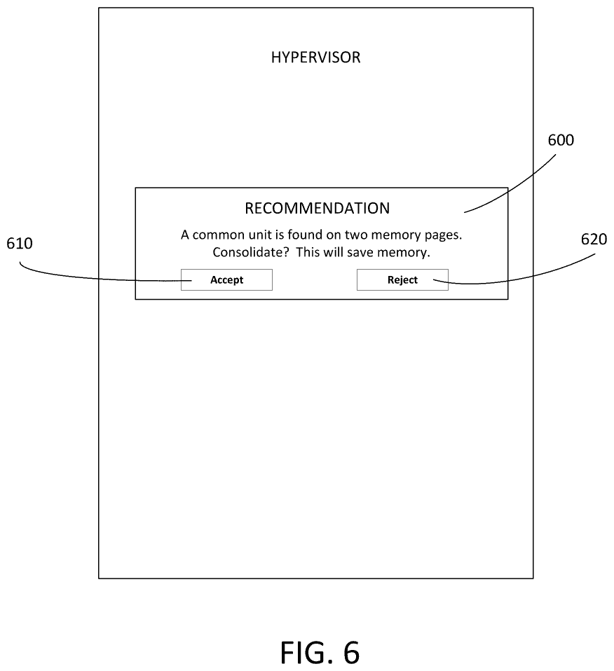

An example recommendation 600 displayed on a display screen of the computing device is shown in FIG. 6 and is related to the example shown in FIGS. 4A and 4B. As can be seen, the recommendation includes a recommendation to consolidate the common unit that is found on the memory tables 400, 410. A selectable interface element 610 is displayed to accept the recommendation and a selectable interface element 620 is displayed to reject the recommendation. The recommendation also includes an indication that this will save memory.

The user of the computing device 110 may select the selectable interface element 610 by performing, for example, a tap gesture on the display screen of the computing device 110 at a location that corresponds to the location of the selectable interface element 610. In response, the computing device 110 may send a signal indicating selection of the selectable interface element 610 to the server computer system 120.

It will be appreciated that a similar recommendation may be used for the example of FIGS. 5A and 5B where the recommendation may include a recommendation to consolidate MID 000000000012345 by removing it from the data record 510 of the second resource node and retaining it on the data record 500 of the first resource node.

The method 300 includes receiving, from the computing device, a signal indicating selection of the selectable interface element for accepting the recommendation (step 340).

The server computer system 120 receives the signal indicating selection of the selectable interface element for accepting the recommendation from the computing device.

The method 300 includes performing operations to consolidate the at least one common resource unit by removing the at least one common resource unit from the at least one future data record of the second resource node and retaining the at least one common resource unit on the at least one future data record of the first resource node (step 350).

Responsive to receiving the signal indicating selection of the selectable interface element for accepting the recommendation, the server computer system 120 performs operations to consolidate the at least one common resource unit by removing the at least one common resource unit from the at least one future data record of the second resource node and retaining the at least one common resource unit on the at least one future data record of the first resource node.

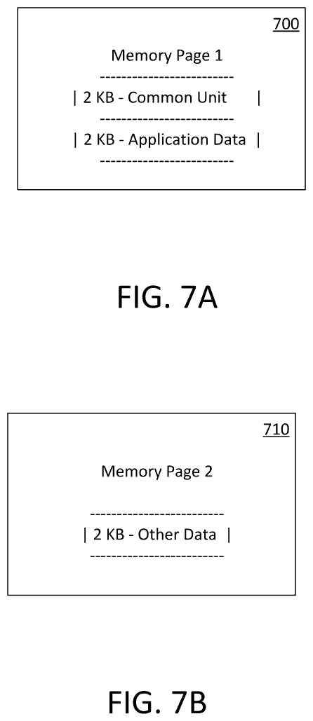

Referring to the example shown in FIGS. 4A and 4B, the server computer system 120 may perform operations to remove the common unit from the memory table 410 and to retain the common unit on the memory table 400. It will be appreciated that in this example, the future data record may refer to the updated memory tables shown in FIGS. 7A and 7B.

An example future data record (or updated memory table) of the first resource node is shown in FIG. 7A. In this example, the first resource node includes a virtual processor and the data record includes an updated memory table 700. The updated memory table 700 retains the common unit.

An example future data record (or updated memory table) of the second resource node is shown in FIG. 7B. In this example, the second resource node includes a virtual processor and the data record includes an updated memory table 710. The updated memory table 710 does not include the “common unit” and as such the space occupied by the common unit in the second resource node is freed up, allowing for more efficient memory usage.

In the example shown in FIGS. 7A and 7B, memory or storage in the second resource node is freed up. Further, management of the common unit is simplified as any changes or updates need only to be made within the memory table of the first resource node. It will be appreciated that any operation or process that previously utilized the common unit from the second resource node will now need to access the first resource node. As such, the server computer system 120 may perform additional operations to route communication to the first resource node.

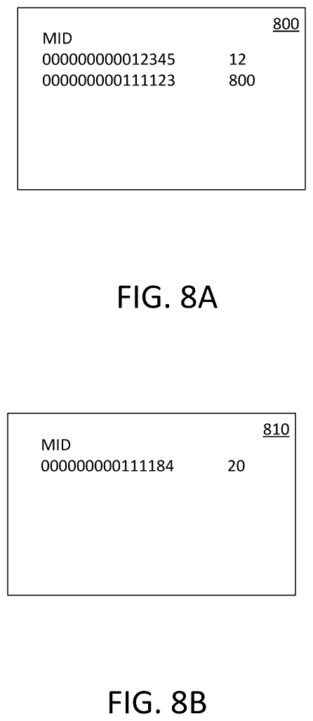

In one or more embodiments, retaining the at least one common resource unit in the at least one future data record of the first resource node may include increasing an allocation of the least one common resource unit to a higher value. Referring to the example of FIGS. 5A and 5B, the server computer system 120 may perform operations to remove the at least one common resource unit in the at least one future data record of the second resource node and may perform operations to increase an allocation of the least one common resource unit to a higher value in the at least one future data record of the first resource node. It will be appreciated that in this example, the future data records may refer to updated data records shown in FIGS. 8A and 8B.

An example future data record (or updated data record) 800 of the first resource node is shown in FIG. 8A. As can be seen, the future data record (or updated data record) 800 of the first resource node includes an increased allocation of the at least one common resource unit. Specifically, the value of MID 000000000012345 has been increased to 12.

An example future data record (or updated data record) 810 of the second resource node is shown in FIG. 8B. As can be seen, the future data record (or updated data record) 810 of the second resource node does not include MID 000000000012345.

In one or more embodiments, the second resource node may be provided access to the at least one common resource unit based on the at least one common resource unit being retained in the at least one future data record of the first resource node. For example, the first resource node and the second resource node may each hold a copy of a configuration file that is accessed when launching a web service. If the service in the second resource node requires configuration settings, it may read the configuration file locally from its own memory or storage. After consolidation, the configuration file may only be held by the first resource node. As such, when the service in the second resource node needs configuration settings, the second resource node may request the configuration file from the first resource node. As such, the second resource node is dependent on the first resource node for the configuration file. Memory in the second resource node is freed up as the configuration file is no longer needed at the second resource node.

In one or more embodiments, upon completion of the consolidation process, any application or process operating with the second resource node that previously accessed the common unit from local memory or storage will now interact with the first resource node. As such, the server computer system 120 may implement caching mechanisms within the second resource node to reduce the frequency of network access or to establish direct communication channels between the first resource node and the second resource node to ensure minimal latency in retrieving the required data.

As mentioned, in one or more embodiments, the at least one common resource unit may be associated with providing access to a particular resource. For example, as mentioned, the at least one common resource unit may include common charges on multiple financial accounts such as for example subscription fees that may be associated with providing access to a particular resource. In this example, operations may be performed to remove the charge on the account of the second resource node and to maintain the charge on the account of the first resource node.

It will be appreciated that in one or more embodiments, the server computer system 120 may require additional operations to be performed to consolidate the at least one resource unit.

For example, the server computer system 120 may require that the user remove the at least one common resource unit from the at least one future data record of the second resource node. In this example, when performing the operations to consolidate the at least one common resource unit by removing the at least one common resource unit from the at least one future data record of the second resource node, the server computer system 120 may send a signal that causes the computing device to display a selectable interface element that includes a deep link embedded therein that causes the computing device to navigate to a web page for requesting the removal of the at least one common resource unit from the at least one future data record of the second resource node.

As mentioned, in one or more embodiments, retaining the at least one common resource unit in the at least one future data record of the first resource node may include increasing an allocation of the least one common resource unit to a higher value. As another example, the first resource node and the second resource node may each hold a copy of a configuration file that is accessed when launching a web service. The configuration file held by the second resource node may include additional information that may not be included in the configuration file held by the first resource node and as such may take up more memory. As such, the server computer system 120 may perform operations to retrieve the additional information from the configuration file held by the second resource node and to add the additional information to the configuration file held by the first resource node and this may increase the amount of memory required to store the configuration file at the first resource node. In this manner, retaining the at least one common resource unit in the at least one future data record of the first resource node may require increasing the allocation of the at least one common resource unit to a higher value. It will be appreciated that this will still reduce the overall memory as memory in the second resource node is greed up as the configuration file is no longer needed at the second resource node.

In one or more embodiments, the server computer system 120 may require that the user increase the allocation of the at least one common resource unit to a higher value in the at least one future data record of the first resource node. In this example, when performing the operations to consolidate the at least one common resource unit by removing the at least one common resource unit from the at least one future data record of the second resource node, the server computer system 120 may send, via the communications module and to the computing device, a signal causing the computing device to display a selectable interface element that includes a deep link embedded therein that causes the computing device to navigate to a web page for increasing the allocation of the at least one common resource unit to the higher value in the at least one future data record of the first resource node.

The deep links described herein may include a Uniform Resource Locator (URL) that hyperlinks to a specific page or piece of a web site or mobile application. The URL may include all information needed to point to a particular item.

In one or more embodiments, the deep link may link to a particular web page for modifying the data record. For example, the third party server may be associated with a virtual computing manager that manages virtual machines. The deep link may link to a specific page of a website or mobile application associated with the third party server. The specific page may include a page for modifying data records of the virtual machines. As another example, the third party server may be associated with a streaming service and may manage data records associated with user accounts. The deep link may link to a specific page of a website or mobile application associated with the third party server. The specific page may include a page for modifying or adjusting the subscription and/or for cancelling the subscription.

The deep links described herein may be maintained by the server computer system 120. For example, the database 140 may maintain a lookup table that associates one or more deep links to one or more consolidation operations and as such each time a consolidation operation is to be performed, the server computer system 120 may retrieve the deep link and assign it to the selectable interface element to complete the consolidation operation.

In accordance with embodiments described herein, the server computer system 120 may determine that common charges are found on multiple linked financial accounts and may perform operations to generate recommendations to remove the charges from one of the financial accounts and to retain the charges on another one of the financial accounts. For example, a first user may subscribe to the subscription service using a first credit card and a second user may subscribe to the subscription service using a second credit card. The server computer system 120 may identify the common charges by analyzing charges on the first credit card account and the second credit card account and may generate a recommendation to cancel the subscription on the second credit card account. A recommendation may be sent to a computing device associated with the second credit card account that includes a recommendation that the user cancel the subscription on the second credit card account. The recommendation may include a selectable interface element that includes a deep link embedded therein that causes the computing device to navigate to a web page for requesting the cancellation of the subscription service. A recommendation may also be sent to a computing device associated with the first credit card account that includes a recommendation that the user upgrade their subscription to allow the second user to access the subscription service using the first user's account. The recommendation may include a selectable interface element that includes a deep link embedded therein that causes the computing device to navigate to a web page for increasing or upgrading the subscription service. In this manner, the first and second user may maintain access to the subscription service while reducing the overall amount of financial resources required. Put another way, rather than paying for two accounts, the first and second user may share an account.

As mentioned, the server computer system 120 may obtain or retrieve resource usage data from one or more sources using a data ingestion engine where the data ingestion engine may be configured to communicate with the one or more sources directly and/or by way of one or more APIs. In one or more embodiments, the data ingestion engine may obtain authentication information from one or more users allowing the data ingestion engine to retrieve the data from the one or more APIs. For example, using the authentication information, the data ingestion engine may integrate with one or more third party servers in an open banking framework. In this example, a third party financial institution may offer account data such as for example bank account data or credit card transaction data to the data ingestion engine via the one or more APIs. By leveraging open banking protocols, the data ingestion engine may access and consolidate account data from multiple sources and for multiple users providing a unified view of financial transactions and/or balances at the request of the multiple users. The multiple users may request the consolidation within, for example, a mobile banking application and this may be done to consolidate accounts between users who may live in the same household, belong to the same family, etc.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
at least one processor;
a communications module coupled to the at least one processor; and
a memory coupled to the at least one processor, the memory storing instructions that, when executed, configure the at least one processor to:
identify at least one common resource unit that is found on at least one data record of a first resource node and at least one data record of a second resource node;
generate a recommendation to consolidate the at least one common resource unit by removing the at least one common resource unit from at least one future data record of the second resource node and retaining the at least one common resource unit on at least one future data record of the first resource node;
send, via the communications module and to a computing device, a signal causing the computing device to display the recommendation and at least one selectable interface element for accepting the recommendation;
receive, via the communications module and from the computing device, a signal indicating selection of the selectable interface element for accepting the recommendation; and
perform operations to consolidate the at least one common resource unit by removing the at least one common resource unit from the at least one future data record of the second resource node and retaining the at least one common resource unit on the at least one future data record of the first resource node.

2. The server computer system of claim 1, wherein the at least one data record includes at least one memory table and the at least one common resource unit includes memory allocation found on the at least one memory table.

3. The server computer system of claim 1, wherein the second resource node is provided access to the at least one common resource unit based on the at least one common resource unit being retained in the at least one future data record of the first resource node.

4. The server computer system of claim 1, wherein the instructions, when executed, further configure the at least one processor to:
analyze the at least one data record of the first resource node and the at least one data record of the second resource node to identify the at least one common resource unit.

5. The server computer system of claim 4, wherein the at least one common resource unit is identified at least by an identifier of the at least one common resource unit.

6. The server computer system of claim 5, wherein the identifier includes at least one of a virtual address, a physical page number, a page frame number, or a merchant identifier.

7. The server computer system of claim 1, wherein the at least one common resource unit is associated with providing access to a particular resource.

8. The server computer system of claim 1, wherein when performing the operations to consolidate the at least one common resource unit by removing the at least one common resource unit from the at least one future data record of the second resource node, the instructions, when executed, further configure the at least one processor to:
send, via the communications module and to the computing device, a signal causing the computing device to display a selectable interface element that includes a deep link embedded therein that causes the computing device to navigate to a web page for requesting the removal of the at least one common resource unit from the at least one future data record of the second resource node.

9. The server computer system of claim 1, wherein retaining the at least one common resource unit in the at least one future data record of the first resource node includes increasing an allocation of the at least one common resource unit to a higher value.

10. The server computer system of claim 9, wherein the instructions, when executed, further configure the at least one processor to:
send, via the communications module and to a second computing device, a signal causing the computing device to display a selectable interface element that includes a deep link embedded therein that causes the computing device to navigate to a web page for increasing the allocation of the at least one common resource unit to the higher value in the at least one future data record of the first resource node.

11. The server computer system of claim 1, wherein when identifying the at least one common resource unit, the instructions, when executed, further configure the at least one processor to:
determine that the at least one common resource unit appears at least a threshold number of times in the at least one data record of the first resource node or the at least one data record of the second resource node.

12. A computer-implemented method comprising:
identifying at least one common resource unit that is found in at least one data record of a first resource node and at least one data record of a second resource node;
generating a recommendation to consolidate the at least one common resource unit by removing the at least one common resource unit from at least one future data record of the second resource node and retaining the at least one common resource unit on at least one future data record of the first resource node;
sending, via a communications module and to a computing device, a signal causing the computing device to display the recommendation and at least one selectable interface element for accepting the recommendation;
receiving, via the communications module and from the computing device, a signal indicating selection of the selectable interface element for accepting the recommendation; and
performing operations to consolidate the at least one common resource unit by removing the at least one common resource unit from the at least one future data record of the second resource node and retaining the at least one common resource unit on the at least one future data record of the first resource node.

13. The computer-implemented method of claim 12, wherein the second resource node is provided access to the at least one common resource unit based on the at least one common resource unit being retained in the at least one future data record of the first resource node.

14. The computer-implemented method of claim 12, further comprising:
analyzing the at least one data record of the first resource node and the at least one data record of the second resource node to identify the at least one common resource unit.

15. The computer-implemented method of claim 14, wherein the at least one common resource unit is identified at least by an identifier of the at least one common resource unit.

16. The computer-implemented method of claim 15, wherein the identifier includes at least one of a virtual address, a physical page number, a page frame number, or a merchant identifier.

17. The computer-implemented method of claim 12, wherein the at least one common resource unit is associated with providing access to a particular resource.

18. The computer-implemented method of claim 12, wherein when performing the operations to consolidate the at least one common resource unit by removing the at least one common resource unit from the at least one future data record of the second resource node, the method further comprises:
sending, via the communications module and to the computing device, a signal causing the computing device to display a selectable interface element that includes a deep link embedded therein that causes the computing device to navigate to a web page for requesting the removal of the at least one common resource unit from the at least one future data record of the second resource node.

19. The computer-implemented method of claim 12, wherein retaining the at least one common resource unit in the at least one future data record of the first resource node includes increasing an allocation of the at least one common resource unit to a higher value.

20. A non-transitory computer readable storage medium comprising processor-executable instructions which, when executed, configure at least one processor to:
identify at least one common resource unit that is found on at least one data record of a first resource node and at least one data record of a second resource node;
generate a recommendation to consolidate the at least one common resource unit by removing the at least one common resource unit from at least one future data record of the second resource node and retaining the at least one common resource unit on at least one future data record of the first resource node;
send, via a communications module and to a computing device, a signal causing the computing device to display the recommendation and at least one selectable interface element for accepting the recommendation;
receive, via the communications module and from the computing device, a signal indicating selection of the selectable interface element for accepting the recommendation; and
perform operations to consolidate the at least one common resource unit by removing the at least one common resource unit from the at least one future data record of the second resource node and retaining the at least one common resource unit on the at least one future data record of the first resource node.
